(19) United States
(12) Patent Application Publication
(10) Pub. No.: US 2007/0192517 A1
(43) Pub. Date: Aug. 16, 2007

(54) APPARATUS FOR UPDATING AUDIOVISUAL EQUIPMENT AND METHOD THEREOF

(76) Inventors: Bor-Yuh Chang, Taipei (TW); Chiu-Yuan Lin, Taipei (TW); Chia-Hsin Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,890

(22) Filed: May 23, 2006

(30) Foreign Application Priority Data
Feb. 10, 2006 (TW) 95104501

(51) Int. Cl. G06F 13/38

(52) U.S. Cl. 710/62

(57) ABSTRACT

An Audiovisual equipment comprises a data input interface, an analog-to-digital (AD) converter, a retrieving circuit and a processing unit burnt with program codes is provided. The data input interface receives analog data from a data source carrying updating data therein. The A/D converter converts the analog data into digital data which is then transmitted to the retrieving circuit. The retrieving circuit retrieves updating data and then transfers it to the processing unit. The processing unit updates the program codes using the updating data.

### CROSS-REFERENCE TO RELATED APPLICATION

This application claims the priority benefit of Taiwan application serial No. 95104501, filed on Feb. 10, 2006. All disclosure of the Taiwan application is incorporated herein by reference.

### BACKGROUND OF THE INVENTION

1. Field of the Invention

The present invention relates to a systematic updating method. More particularly, the present invention relates to a systematic method for updating an audiovisual equipment.

2. Description of the Related Art

With our eager demand for higher living quality, many home electrical appliances have been prosperously developed, wherein a home audiovisual equipment is an obvious example. Moreover, during the weekend, taking the whole family out for a journey has become popular since a five-day work system is implemented by most companies. As travelers dissatisfied with conventional audio broadcasting equipment's functionality and feel boring inside a car during their long driving journey, many types of car carried audiovisual equipment have gradually been developed. At present, many types of car carried audiovisual equipment have become a standard equipment inside most automobiles.

FIG. 1 is a diagram showing firmware for updating conventional audiovisual equipment. As shown in FIG. 1, the conventional audiovisual equipment 100 including the DVD, VCD or CD display apparatus has a central processing unit 110 in which program codes 110 is burnt. In order to make the product more competitive and debug any errors in the program codes, the program codes 112 are normally firmware that can be updated. To facilitate the updating of the program codes 112, a data transmission channel is normally set aside in the conventional audiovisual equipment 100.

The conventional method for updating the audiovisual equipment includes connecting an updating equipment such as a personal computer 120 to the data transmission channel of the audiovisual equipment 100. Then, new program codes are transmitted to the central processing unit 110 via the data transmission channel for renewing the original program codes 112.

However, not everyone has a capability of updating the program codes 112. Therefore, most conventional updating processes need to be carried out by professionals, thereby causing a rather high updating cost. Furthermore, it is difficult to reserve a data transmission channel for firmware updating in a car carried audiovisual equipment so as to cause rather inconvenient in equipment maintenance.

### SUMMARY OF THE INVENTION

Accordingly, one objective of the present invention is to provide an updating mechanism that does not require additional equipment and yet allows anyone to update firmware of audiovisual equipment through a few simple steps.

To achieve these and other advantages and in accordance with the purpose of the invention, as embodied and broadly described herein, the invention provides an updating circuit for audiovisual equipment. The updating circuit comprises a data input interface, an analogue-to-digital (AD) converter and a retrieving circuit. The data input interface receives analogue data from a data source carrying updating data therein. The AD converter converts the analogue data into digital data and then transmits it to the retrieving circuit. The retrieving circuit retrieves the updating data for updating the firmware of the audiovisual equipment.

According to another perspective, the present invention also provides an audiovisual equipment having a processing unit and the aforementioned updating circuit. The processing unit includes burnt program codes to serve as firmware of the audiovisual equipment. After the aforementioned retrieving circuit has retrieved the updating data, the updating data is transmitted to the processing unit so that the program codes inside the processing unit can be updated.

In one preferred embodiment, the foregoing analogue data includes at least one of video data and audio data.

In addition, the data source for providing the analogue data may be an optical storage medium.

In some selected embodiments, the foregoing data input interface can be implemented through an antenna.

According to another perspective, the present invention also provides an updating method for an audiovisual equipment. The updating method includes loading updating data into analogue data and transmitting the analogue data to the audiovisual equipment. The audiovisual equipment then retrieves the updating data from the analogue data and using the updating data to update its firmware.

In the present invention, the updating data is carried inside analogue data such as video or audio data. Therefore, the user only plays the analogue data and the updating circuit of the present invention retrieves the updating data and automatically updates the program codes within the processing unit. In other words, the user can update the firmware of digital broadcasting equipment without having to perform complicated steps or to need additional equipment.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing conventional apparatus for updating firmware of audiovisual equipment.

FIG. 2 is a circuit block diagram of one type of audiovisual equipment according to one preferred embodiment of the present invention.

FIG. 3 is a flow diagram showing the steps for updating audiovisual equipment according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

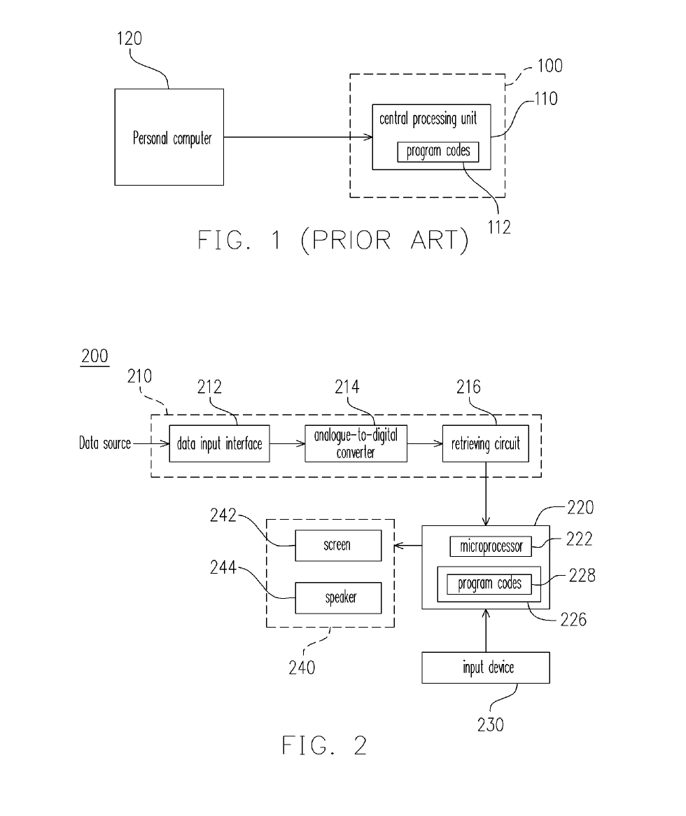

FIG. 2 is a circuit block diagram of one type of an audiovisual equipment according to one preferred embodiment of the present invention. As shown in FIG. 2, the audiovisual equipment 200 according to the present invention may be, for example, a DVD, VCD, CD, radio, digital television. The audiovisual equipment 200 further includes an updating circuit 210 for receiving analogue data provided by a data source and supplying the analogue data to a processing unit 220. In the present invention, the analogue data supplied by the data source also carries updating data.

In the embodiment of the present invention, the data source may be an optical storage medium such as a DVD, a VCD or a CD. The aforementioned analog data may be video data and/or audio data stored inside the optical storage medium. In another embodiment, the data source may be a broadcasting station, a wireless television station or a cable television station. The analog data may be the broadcasting program or the television program from these broadcasting stations or television stations, but the present invention is not limited thereto.

Additionally, in some embodiments, the audiovisual equipment 200 may also include an input device 230 and an output device 240. The input device 230 includes a number of functional keys and the output device 240 includes a display screen 242 and a speaker 244. In some other selected embodiments, the output device 240 may be, for example, an externally connected apparatus such as a flat display.

In the present invention, the processing unit 220 may be implemented as a central processing unit. In the processing unit 220 is burnt with program codes 228 for serving as firmware for the audiovisual equipment 200. In an actual operation, the processing unit 220 retrieves analog data such as audio/video data (or a multi-medium signal) from a data source through the updating circuit 210 according to the instruction fed to the input device 230, and outputs the data to the user via the output device 240. For example, image frames are output via a screen 242 and sound messages are output via a speaker 244.

In some embodiments, the processing unit 220 may includes a micro-processing unit 222 and a program memory 226. The program memory 226 is used for storing program codes 228. In general, the program memory 226 may be implemented using flash memory or electrically erasable programmable read-only-memory. In another selected embodiments, the processing unit 220 may includes a microprocessor and a digital signal processor. In addition, the present invention is not limited to the processing unit 220 structure.

Referring to FIG. 1, the updating circuit 210 includes a data input interface 212 for retrieving the analog data (or the multi-medium signal) from the data source and transmitting the analog data to an analog-to-digital (A/D) converter 214. The A/D converter 214 coverts the output from the data input interface 212 into a digital form and then transfer it to the retrieving circuit 216. The retrieving circuit 216 retrieves updating data from the output of the A/D converter 214 and then transfers it to the processing unit 220 so as to update the program codes 228 .

If the data source is an optical storage medium, the data input interface 212 reads the analog data carrying updating data therein from the optical storage medium and transfer the analog data to the analogue-to-digital (A/D) converter 214. The A/D converter 214 converts the analog data into digital data. Then, the retrieving circuit 216 retrieves the updating data and then transmits it to the processing unit 220 for updating the program codes 228. Meanwhile, the processing nit 220 outputs the received analog data via the output device 240.

On the other hand, if the data source is a broadcasting station or a television station, the data input interface 212 may be implemented using an antenna. The updating circuit 210 can utilize the data input interface 212 to receive the analog data carrying the updating data therein and then transmits the analog data to the processing unit 220 through the foregoing process so to update the program codes 228.

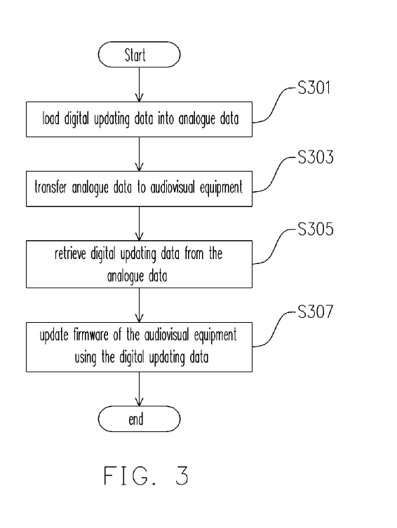

FIG. 3 is a flow diagram showing the steps for updating audiovisual equipment according to one preferred embodiment of the present invention. Referring to FIG. 3, one critical technique in the present invention is to carry the updating data into the analog data such as audio/video data, as shown in step S310. Then, in step S303, the analog data carrying the updating data therein is transmitted to the audiovisual equipment. Thereafter, in step S305, the audiovisual equipment retrieves the updating data from the analog data. Finally, in step S307, the updating data is used to update the firmware program.

Through the technique implemented in the present invention, the manufacturers of audiovisual equipment may collaborate with film makers so that the updating data for the audiovisual equipment is embedded within the preview advertisement of a movie disc or a music disc. In other words, the firmware of the audiovisual equipment may be updated during the user's watching movie without any perception to the updating procedure through the preview period prior to playing the movie after the user puts the movie disc into the audiovisual equipment.

In addition, in some selected embodiments, the manufacturers of audiovisual equipment may collaborate with television stations or broadcasting stations so that the updating data is embedded within the broadcasting programs. Therefore, as the user turns on the audiovisual equipment to listen or watch programs, the firmware of the audiovisual equipment can be updated concurrently.

In summary, the updating data is piggybacked into the analog data such as audio/video data in the present invention so that the analog data can be transferred to the audiovisual equipment and then the updating data component can be retrieved to update the firmware. Thus, advantages of the present invention at least include:

1. The firmware of the audiovisual equipment can be updated directly without additional updating equipment.

2. The firmware of the audiovisual equipment can be updated directly without the need for reserving a data transmission channel in the audiovisual equipment.

3. A technician specializing in the data updating process is not required. In fact, anyone is able to update the audiovisual equipment firmware by himself or herself.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A circuit for updating an audiovisual equipment, comprising:
a data input interface for receiving analog data from a data source, wherein the analog data carries a updating data;
an analog-to-digital converter for converting the analog data into a digital data; and
a retrieving circuit coupled to the analog-to-digital converter for retrieving the updating data from an output of the analogue-to-digital converter and using the updating data to update firmware of the audiovisual equipment.

2. The circuit of claim 1, wherein the analog data includes one of video data and audio data.

3. The circuit of claim 1, wherein the data source comprises an optical storage medium.

4. The circuit of claim 1, wherein the data input interface comprises an antenna.

5. An audiovisual equipment, comprising:
a processing unit having program codes:
a data input interface for receiving analog data from a data source, wherein the analogue data also carries updating data;
an analog-to-digital converter for converting the analog data into digital data; and
a retrieving circuit coupled to the analog-to-digital converter for retrieving the updating data from an output of the analog-to-digital converter and transmitting the updating data to the processing unit for updating the program codes inside the processing unit.

6. The audiovisual equipment of claim 5, further comprising:
an input device coupled to the processing unit for transmitting user's instructions to the processing unit; and
an output unit coupled to the processing unit for outputting audio/video data to the user.

7. The audiovisual equipment of claim 6, wherein the output unit comprises a screen and a speaker.

8. The audiovisual equipment of claim 5, wherein the analog data comprises one of video data and audio data.

9. The audiovisual equipment of claim 5, wherein the data source comprises an optical storage medium.

10. The audiovisual equipment of claim 5, wherein the data input interface comprises an antenna.

11. The audiovisual equipment of claim 5, wherein processing unit comprises a microprocessor and a program memory for storing the program codes.

12. The audiovisual equipment of claim 11, wherein the program memory comprises a flash memory or an electrically erasable programmable memory.

13. The audiovisual equipment of claim 5, wherein the processing unit comprises a microprocessor and a digital signal processor.

14. A method for updating firmware of an audiovisual equipment, comprising the steps of:
loading updating data into analog data;
transmitting the analog data to the audiovisual equipment;
retrieving the updating data from the analog data; and
utilizing the updating data to update the firmware of the audiovisual equipment.

15. The updating method of claim 14, further comprises a step of converting the analog data into a digital data.

16. The updating method of claim 14, wherein the analog data comprises one of video data and audio data.

17. The updating method of claim 14, wherein the firmware of the audiovisual equipment comprises program codes burnt within the central processor.

18. The updating method of claim 14, further comprises a step of burning the analog data into an optical storage medium.

19. An audiovisual equipment, comprising:
a data input interface, receiving and outputting a multi-medium signal carrying a updating data; and
a retrieving circuit, receiving the multi-medium signal from the data input interface, retrieving the updating data from the multi-medium signal so as to update a device connectable to the retrieving circuit.

20. The audiovisual equipment of claim 19, wherein a source of the multi-medium signal is selected from one of the group consisting of an optical storage device, a wire signal and a wireless signal.

21. The audiovisual equipment of claim 19, further comprises:
an analog-to-digital converter, disposed on a path of the multi-medium signal between the data input interface and the retrieving circuit, and digitalizing the multi-medium signal, thereby allowing the retrieving circuit to retrieve the updating data.

22. The audiovisual equipment of claim 19, wherein the device connectable to the retrieving circuit is a processing unit built in the audiovisual equipment, and the updating data can be utilized to update the program codes of the processing unit.

23. The audiovisual equipment of claim 22, wherein the processing unit comprises a microprocessor and a programmable memory that stores the program codes.

24. The audiovisual equipment of claim 23, wherein the programmable memory is one of a flash memory and an electrically erasable programmable read-only-memory.

25. The audiovisual equipment of claim 22, wherein the processing unit comprises the microprocessor and a digital signal processor.

26. The audiovisual equipment of claim 22, further comprises:
an input device coupled to the processing unit, transmitting a user's command to the processing unit; and
an output unit coupled to the processing unit, outputting audio/video data to the user.

27. The audiovisual equipment of claim 26, wherein the output unit comprises a screen and a speaker.

28. The audiovisual equipment of claim 19, wherein the data input interface is one of a wireless receiver and a wire receiver.

29. The audiovisual equipment of claim 19, wherein the multi-medium signal comprise a video signal and an audio signal.

30. The audiovisual equipment of claim 19, wherein the device connectable to the retrieving circuit is a computer for driving.

31. A method for displaying an audiovisual equipment, comprising:
loading an updating data into a multi-medium signal;
receiving the multi-medium signal carrying the updating data;
retrieving the updating data from the multi-medium signal; and
updating data built in a device by using the updating data retrieved from the multi-medium signal.

32. The method for displaying an audiovisual equipment of claim 31, further comprises digitalizing the multi-medium signal carrying the updating data and thereby retrieving the updating data.

33. The method for displaying an audiovisual equipment of claim 32, the device is selected from one of the group consisting of a firmware, a processing unit, an audio/video apparatus and a computer for driving.
